(19) United States
(12) Patent Application Publication
(10) Pub. No.: US 2012/0089404 A1
(43) Pub. Date: Apr. 12, 2012

(54) GLOBAL PRICING FOR CONTENT DISTRIBUTION

(75) Inventors: Mihir Rao, Issaquah, WA (US); Kamran Rajabi Zargahi, Seattle, WA (US)

(73) Assignee: Microsoft Corporation, Redmond, WA (US)

(21) Appl. No.: 12/917,178

(22) Filed: Nov. 1, 2010

Related U.S. Application Data
(60) Provisional application No. 61/390,596, filed on Oct. 6, 2010.

(51) Int. Cl. G06Q 30/00; G06Q 90/00

(52) U.S. Cl. 705/1.1; 705/500

(57) ABSTRACT

In embodiments of global pricing for content distribution, price points at which content is distributed for sale in a base currency can be determined, and a base price point selected from the price points. Currency value equivalents to the selected base price point may then be obtained for multiple currencies. A base price tier is populated with base prices that include the selected base price point and the currency value equivalents for the multiple currencies. A tax amount for each of the base prices in the base price tier can be calculated, and the calculated tax amount added to the base prices to generate tax-based prices in the base price tier. The tax-based prices can then be increased to a common price ending for each of the multiple currencies to generate the base price tier of global base prices.

### RELATED APPLICATION

This application claims priority to U.S. Provisional Application Ser. No. 61/390,596 filed Oct. 6, 2010, entitled “Global Pricing for Content Distribution” to Rao et al., the disclosure of which is incorporated by reference herein in its entirety.

### BACKGROUND

An individual content developer may create an application, such as a mobile phone application, that a consumer can then download to a mobile phone or other portable media device. The challenges associated with pricing, distribution, and sale of the application may be far more formidable to the content developer than creating the application itself. Some content stores or application stores provide a central on-line distribution point where content developers can upload content that has been created for distribution to consumers who may then download the content to user devices. Although a content developer may be particularly adept at creating new applications for consumers, the content developer may be less comfortable when it comes to pricing the content for sale, particularly in the many different currencies for distribution in a global economy.

### SUMMARY

This summary is provided to introduce simplified concepts of global pricing for content distribution, and the concepts are further described below in the Detailed Description. This summary is not intended to identify essential features of the claimed subject matter, nor is it intended for use in determining the scope of the claimed subject matter.

Global pricing for content distribution is described. In embodiments, price points at which content is distributed for sale in a base currency can be determined, and a base price point selected from the price points. Currency value equivalents to the selected base price point may then be obtained for multiple currencies. A base price tier is populated with base prices that include the selected base price point and the currency value equivalents for the multiple currencies. A tax amount for each of the base prices in the base price tier can be calculated, and the calculated tax amount added to the base prices to generate tax-based prices in the base price tier. The tax-based prices can then be increased to a common price ending for each of the multiple currencies to generate the base price tier of global base prices. Additionally, increment values can be calculated for each of the multiple currencies that are represented by the global base prices in the base price tier, and additional price tiers generated based on the increment values for each of the respective multiple currencies.

### BRIEF DESCRIPTION OF THE DRAWINGS

Embodiments of global pricing for content distribution are described with reference to the following drawings. The same numbers are used throughout the drawings to reference like features and components:

FIG. 1 illustrates an example system in which embodiments of global pricing for content distribution can be implemented.

FIG. 2 illustrates an example base price tier as described with reference to one or more embodiments of global pricing for content distribution.

FIG. 3 illustrates an example of projected exchange rate fluctuations as described with reference to one or more embodiments of global pricing for content distribution.

FIG. 4 illustrates example price tiers as described with reference to one or more embodiments of global pricing for content distribution.

FIG. 5 illustrates an example exception price tier as described with reference to one or more embodiments of global pricing for content distribution.

FIGS. 6-9 illustrate example methods of global pricing for content distribution in accordance with one or more embodiments.

FIG. 10 illustrates various components of an example device that can implement embodiments of global pricing for content distribution.

### DETAILED DESCRIPTION

Embodiments of global pricing for content distribution are described. A pricing service is implemented to simplify pricing content for content developers and/or content providers that endeavor to distribute the content for sale in many different currencies and countries worldwide. The pricing service can generate price tiers that are selectable by a content developer or provider to automatically price the content globally. The price tiers can be generated from a single price point in a selected base currency, and the price tiers include the currency value equivalents for multiple currencies that are associated with many different countries and/or regions. In embodiments, the pricing service accounts for currency exchange rates, tax rates in the many different countries, common price endings for consumer perception of the content that is for sale, and mobile operator billing support when the equivalent prices are auto-generated in multiple currencies based on the selection of a content price in one currency in one country.

While features and concepts of the described systems and methods for global pricing for content distribution can be implemented in any number of different environments, systems, devices, and/or various configurations, embodiments of global pricing for content distribution are described in the context of the following example devices, systems, and configurations.

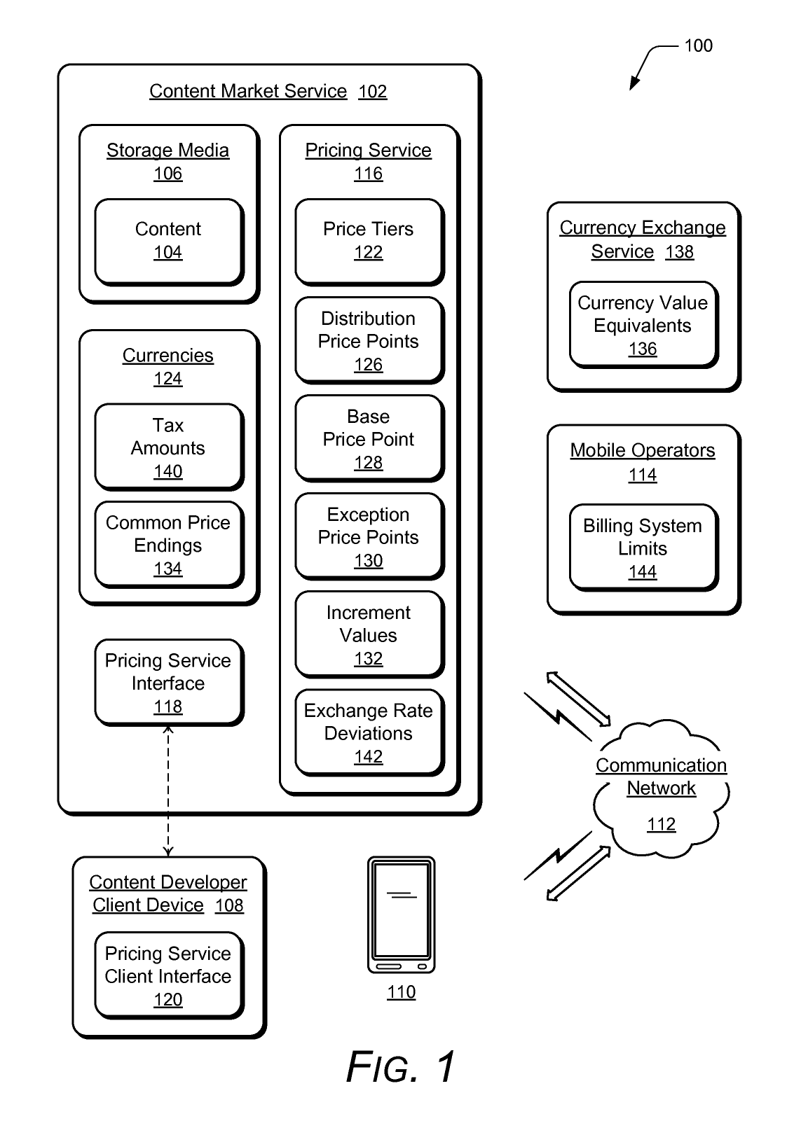

FIG. 1 illustrates an example system 100 in which various embodiments of global pricing for content distribution can be implemented. The example system 100 includes a content market service 102 from which various content 104 is distributed for sale. The content 104 may include applications, music, videos, movies, games, and any other types of audio, video, and/or image content. The content market service can support pricing for all types of content that may sell at different prices due to differing business models and competitive application development. The content market service includes storage media 106 to store or otherwise maintain the various content and data, such as any type of content 104. The storage media can be implemented as any type of memory and/or suitable electronic data storage.

A content developer at a client device 108 can create an application, such as a mobile phone application, and upload the application to the content market service 102 for sale and distribution. A consumer with a consumer device 110, such as a mobile phone or a portable media device, can then initiate a purchase of the content. For example, a consumer may pay to download an application to a mobile phone, or pay to download a digital music track to a portable media device.

The example system 100 includes a communication network 112 via which any of services and devices communicate. The communication network can be implemented to include a wired and/or a wireless network that facilitates content distribution and data communication. The communication network can also be implemented using any type of network topology and/or communication protocol, and can be represented or otherwise implemented as a combination of two or more networks. The communication network may also include mobile operator networks that are managed by mobile operators 114, such as a communication service provider, cell-phone provider, and/or Internet service provider. A mobile operator can facilitate mobile data and/or voice communication for any type of a wireless device or mobile phone (e.g., cellular, VoIP, Wi-Fi, etc.).

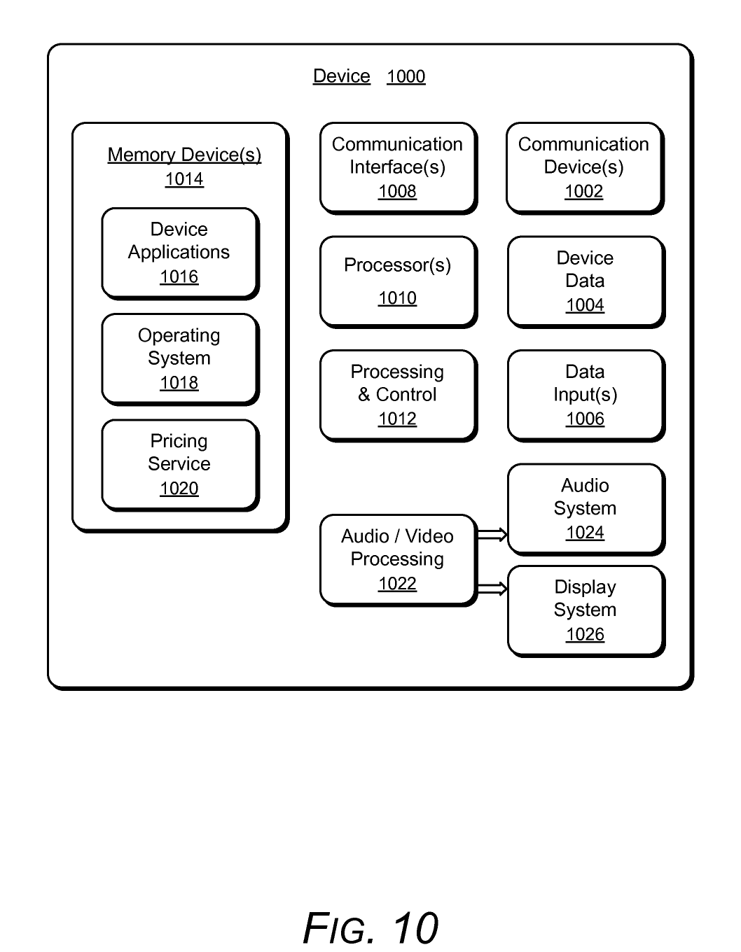

In this example system 100, the content market service 102 includes a pricing service 116 that can be implemented as computer-executable instructions, such as a software application, and executed by one or more processors to implement the various embodiments described herein. The content market service can also be implemented with any number and combination of differing components as further described with reference to the example device shown in FIG. 10. Additionally, the content market service and the pricing service may be implemented as independent services (e.g., on separate servers or by a third party service), or as one combined service.

The content market service 102 also includes a pricing service interface 118 for content developer access to the pricing service 116 that is implemented for global pricing of the content 104. The content developer client device 108 can include a pricing service client interface 120 by which a content developer initiates a request for price tiers 122 in a base currency to price content for sale in multiple currencies 124, such as to set global prices for a mobile phone application that the content developer has created and uploaded to the content market service for sale and distribution.

In embodiments, the pricing service 116 is implemented to generate the price tiers 122 to price the content 104 for sale in the multiple currencies 124. Initially, the pricing service can determine distribution price points 126 at which the content is distributed for sale in a base currency. A base currency may be relative to the country where a content developer resides and develops content for sale and distribution, and/or the base currency may be selected for business reasons. For example, a base currency may be chosen depending on factors such as low exchange rate fluctuations (e.g., USD or EUR), or currency that is preferred for business in a particular region and/or countries (e.g., USD for business in the United States and EUR for business in Europe).

The distribution price points 126 may be relative to multiple types of the content 104, and are price points at which the content is distributed for sale. As described above, the content may include applications, music, videos, movies, games, and any other types of content that may sell at different prices. For example, in a base currency of USD, the minimum sale price for music may be $0.69 and the minimum sale price for an application may be $0.99. Since $0.69 is the lowest price point (or may be a new lowest price point), $0.69 can be used to generate the first price tier (also referred to as the lowest price tier, or the base price tier).

A unique price point, such as $1.29, that only applies to music may be added as a new or additional price tier because it only applies to one type of the content. A distribution price point 126 that is unique to a particular type of content can be added as a new price point that all of the other content types may be sold at. Other considerations may include limiting or restricting distribution price points to include only the price points for a particular type of content (e.g., $0.69 may be available only for music, but not for applications or games); only the price points for a particular payment method (e.g., $0.99 may only be available for credit card billing, but not mobile operator billing); or only the price points for a particular currency and/or in a particular country (e.g., [symbol] 5.49 may be available only in Germany, but not in any other EU countries that are based on EUR). In embodiments, the pricing service 116 can dynamically evaluate if a distribution price point for a type of content is to be added as the new lowest price tier, or added as an additional price tier.

A base price point 128 and exception price points 130 are the starting price points for generating a base price tier and exception price tiers, respectively. A base price tier 122 is generated to include global base prices for the multiple, different currencies 124, and increment values 132 can be added to each of the global base prices to generate subsequent, additional price tiers 122. The base price point 128 is the price point in the base price tier from which the other global base prices are determined. The base price tier is not necessarily the lowest price tier generated by the pricing service as based on the lowest distribution price point. An exception price tier 122 is generated from an exception price point 130, which is used to determine other global exception prices in the exception price tier. In implementations, an exception price tier is not used to generate additional price tiers, nor is an exception price tier generated from the base price tier.

The pricing service 116 can identify a minimum price from the distribution price points 126, increase the minimum price to a common price ending to generate a common minimum price, and then determine an increment value as the difference between the common minimum price and the minimum price. For example, sales research shows that the common price endings 134 for most products sold in the United States in USD are $0.49 and $0.99. Most countries and corresponding currencies have common price endings, which may be derived from consumer advertising and purchase patterns. From the example above, $0.69 is the minimum price from the determined distribution price points 126. The minimum price is increased to the common price ending of $0.99, referred to as the common minimum price. An increment value 132 is then determined to be $0.30 (i.e., the common minimum price of $0.99 minus the minimum price of $0.69).

If a calculated increment value 132 uniformly adds to the global base prices in a base price tier to generate additional price tiers 122, then the pricing service 116 selects the minimum price as the base price point 128. Alternatively, if a calculated increment value does not uniformly add to the global base prices in the base price tier to generate the additional price tiers, then the pricing service identifies the minimum price as an exception price point 130. In this instance, an increment value of $0.30 (i.e., $0.99 minus $0.69) is not a good increment value from which to generate the additional price tiers, and the pricing service identifies the minimum price point of $0.69 as an exception price point. The pricing service can then select $0.99 as the base price point, and the increment value would be 1.0 (i.e., $1.99 minus $0.99), which is a good increment value from which to generate the additional price tiers.

Once the base price point 128 is selected, the pricing service 116 can obtain currency value equivalents to the selected base price point for the multiple currencies. The pricing service can auto-generate the global base prices for all of the currencies 124 from a base price point selected in one currency. The pricing service can request, and then receive, the currency value equivalents 136 from a currency exchange service 138, such as from Reuters, the U.S. Federal Reserve, a foreign exchange service, or other sources for currency exchange rates. The currency value equivalents may be automatically updated from a currency exchange service on any periodic schedule (e.g., hourly, daily, weekly, monthly, etc.). Alternatively or in addition, the price tiers 122 may be updated when the exchange rate for a currency exceeds a set range or defined threshold.

The pricing service 116 is implemented to calculate a tax amount 140 for each of the base prices (i.e., the selected base price point and the currency value equivalents for the multiple currencies) in the base price tier. The calculated tax amounts are then added to the base prices to generate tax-based prices for respective currencies in which the calculated tax amount is collected along with a sale of the content. The tax amounts are calculated for each currency and/or corresponding country based on the prevailing tax rates, and the tax amounts are then included or excluded in the base prices so that taxes are collected in compliance with each country's tax regulations.

In countries (and for currencies) where the sale price of content includes a tax, the tax-based prices are calculated as the base price plus the base price multiplied by the tax rate. In countries (and for currencies) where the sale price of content excludes tax, the tax-based price is the same as the base price in the base price tier. The pricing service 116 can be implemented to request and receive the country-specific and/or currency-specific tax regulations and tax rates from any tax data source, update the price tiers if the tax rate change for a country and/or currency exceeds a set range, update the price tiers for taxes other than sales tax, and in countries where the sale price for content excludes tax, show the tax amount that a consumer will pay.

The pricing service 116 is then implemented to increase the tax-based prices to a common price ending 134 for each of the multiple currencies 124 to generate the global base prices in the base price tier. The global base prices with tax included or excluded is increased to align with common price endings 134, such as $0.49 or $0.99 in the USA, EU, and UK; [symbol] 0.05, [symbol] 0.10, [symbol] 0.50, or [symbol] 0.00 francs in Switzerland; and by multiples of ten (10) in Australia, India, Hong Kong, and Mexico. The price tier values then reflect the common price endings in each currency and corresponding country so that the content sale prices are considered customer friendly, or more likely to entice a sale. In an implementation, this can be accomplished by extracting the trailing digits from a price tier value and rounding them up, or increasing, to the next common price ending for a currency. Some currencies have multiple common price endings (e.g., in the USA, the most common price ending is $0.99, but it is also common to have price endings in $0.49, $0.50, or $0.00). Alternatively or in addition, increasing the price tier values for country-specific or currency-specific common pricing endings can include more than one common price ending, such as $0.50 or $0.99 in the USA.

The pricing service 116 is implemented to calculate the increment values 132 for each of the multiple currencies 124 that are represented by the global base prices in the base price tier, and then generate the additional price tiers 122 based on the increment values for each of the respective multiple currencies. The additional price tiers are generated by adding an increment value to a corresponding base price. The increment values also take into account the tax amount 140 for a currency, since tax is collected in compliance with local tax regulations for the global prices in each price tier. In embodiments, the pricing service may utilize multiple increment values such that an increment value is applied to a range of price tiers. For example, a first increment value may be used as a basis to generate the first ten price tiers, and a second increment value may be used to generate price tiers eleven through fifty, and so forth. The price points in a next price tier can also be normalized by increasing the price points to a common price ending for each of the respective multiple currencies.

The pricing service 116 is also implemented to project exchange rate fluctuations or deviations plus and minus that may affect the global prices in a price tier, and then adjust the global prices based on an exchange rate deviation 142 that would negatively affect a sale of the content. Because the base price tier is the basis used to generate all of the other price tiers 122, the pricing service 116 takes into account the exchange rate deviations.

Exchange rate fluctuations or deviations can be considered based on historical or hypothetical analysis. In one example, a price point in a price tier is considered, and referred to as price1. The tax amount is added to the price point to generate a tax-based price point, referred to as price2, and the tax-based price point is increased to a common price ending, referred to as price3. A difference between price2 and price3 is calculated, and a tax on the difference is then calculated. A revenue is then determined as the difference minus the tax. The tax-based price point labeled price2 can then be increased and decreased to simulate a strengthening and a weakening of the particular currency. The tax-based price point labeled price2 can then be selected so that the revenue has some buffer for currency exchange rate fluctuations, and to keep the revenue a positive value.

The pricing service 116 can also limit a global price in a price tier so as not to exceed a billing limit 144 of a mobile operator 114 that allows a consumer to charge for a purchase of the content. Mobile operator billing systems can differ between the various mobile operators within a country or region. Some of the mobile operator billing systems are based on legacy premium SMS (also referred to as pSMS) billing systems and can bill only specific, fixed price points. The pricing service can be implemented to take into account any of the specific, fixed price points for the various mobile operators and to identify the price tiers 122 which are supported and unsupported by the mobile operators.

In addition, some mobile operators have billing system limits on the maximum amount that can be charged per consumer to reduce liability. The billing system limits can be enforced with a combined effort from the pricing service and a mobile operator. For example, the pricing service can be implemented to limit global prices so as not to exceed a billing limit of a mobile operator, and the mobile operator can check the credit balance of a consumer account before charging for the sale of content. In other embodiments, the pricing service can be implemented to maintain a central account balance for a consumer regardless of the mobile operator that is associated with a consumer device. This allows the consumer to switch seamlessly between mobile operators without worrying about the credit balance.

In other embodiments, the global prices in the price tiers 122 can be limited to mitigate risk from fraudulent purchases and non-payment from consumers. The pricing service 116 can implement a risk mitigation limit based on such factors as the fraud prevention capabilities of a particular mobile operator's billing system, a billing relationship with a particular consumer, the risk of not collecting revenue that the business can bear, and/or any regulations that apply to a specific type of payment method. The highest price tier can be generated to be less than or equal to the risk mitigation limit.

As the pricing service 116 generates the price tiers 122, the number of price tiers can be reduced based on pricing history and data. For example, the number of price tiers can be reduced for ease of selection by content providers when selecting a price tier, and/or for the feasibility of displaying the price tiers, such as at the content developer client device 108 in the pricing service client interface 120. The pricing service can be implemented to reduce the number of price tiers based on pricing history data and to segregate price points of the base currency, such as by most frequently used, frequently used, and least frequently used. Some of the price tiers 122 can then be eliminated based on frequency of use.

The pricing history may be obtained from one or more data sources, and may be based on an average sale price as set by a content provider per currency or by the currency of the base price point. The pricing history may also be based on an average sale price of the content to consumers per currency or by the currency of the base price point. The pricing history may also be based on the sale prices of content via different types of client devices and/or via different types of content playback interfaces. For example, the pricing service can be implemented for different content purchasing scenarios, such as to purchase television content via a television system, and/or for different payment methods, such as a credit card, direct debit, a payment service, or other types of payment methods.

As described above with reference to the pricing service 116 generating the price tiers 122, the pricing service can also generate an exception price tier of global exception prices based on an identified exception price point 130. The pricing service can obtain the currency value equivalents 136 to an exception price point for the multiple currencies, and auto-generate the global exception prices for all of the currencies 124. The pricing service can then calculate a tax amount 140 for each of the global exception prices, increase the tax-based exception prices to a common price ending 134 for each of the multiple currencies, and project currency exchange rate deviations plus and minus that may affect the global exception prices in the exception price tier.

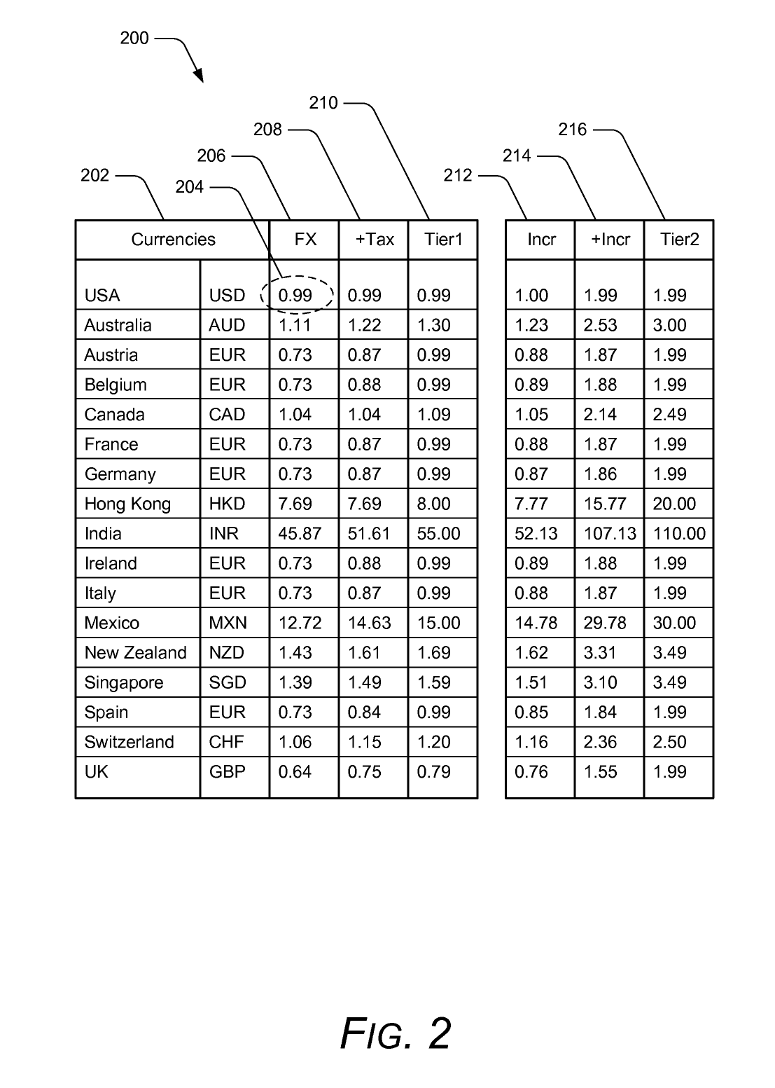

FIG. 2 illustrates an example base price tier 200 as described with reference to FIG. 1. The base price tier 200 includes various currencies 202, and a base price point 204 of $0.99 in USD. The base price tier also includes the currency value equivalents 206 of the selected base price point for the multiple currencies. As described herein, the base prices in the base price tier include the base price point 204 and the currency value equivalents 206.

The base price tier 200 also includes the tax-based prices 208, which are the calculated tax amounts added to the base prices for each the respective currencies 202 in which the calculated tax amount is collected along with a sale of the content. For example, a tax amount of [symbol] 0.14 (i.e., [symbol] 0.87 minus [symbol] 0.73) is collected in Austria along with a sale of the content, where the tax-based price of [symbol] 0.87 is calculated as the base price of [symbol] 0.73 plus the base price multiplied by the Austria tax rate. In another example, the sale price of content in Canada excludes tax, and the tax-based price of 1.04 CAD is the same as the base price of 1.04 CAD in the base price tier. The base price tier also includes the tax-based prices for each of the respective currencies increased to a common price ending, which are reflected as the Tier1 global base prices 210. For example, the tax-based price of [symbol] 0.87 EUR for Austria is increased to the common price ending of [symbol] 0.99 EUR.

The base price tier 200 also includes increment values 212 for each of the various currencies 202, and includes base-plus-increment prices 214. For example, the increment value of 1.0 that is associated with the USD is added to the Tier1 global base price of $0.99 for a base-plus-increment price of $1.99. The base price tier also includes the base-plus-increment prices for each of the respective currencies increased to a common price ending, which is reflected as the Tier2 global base prices 216.

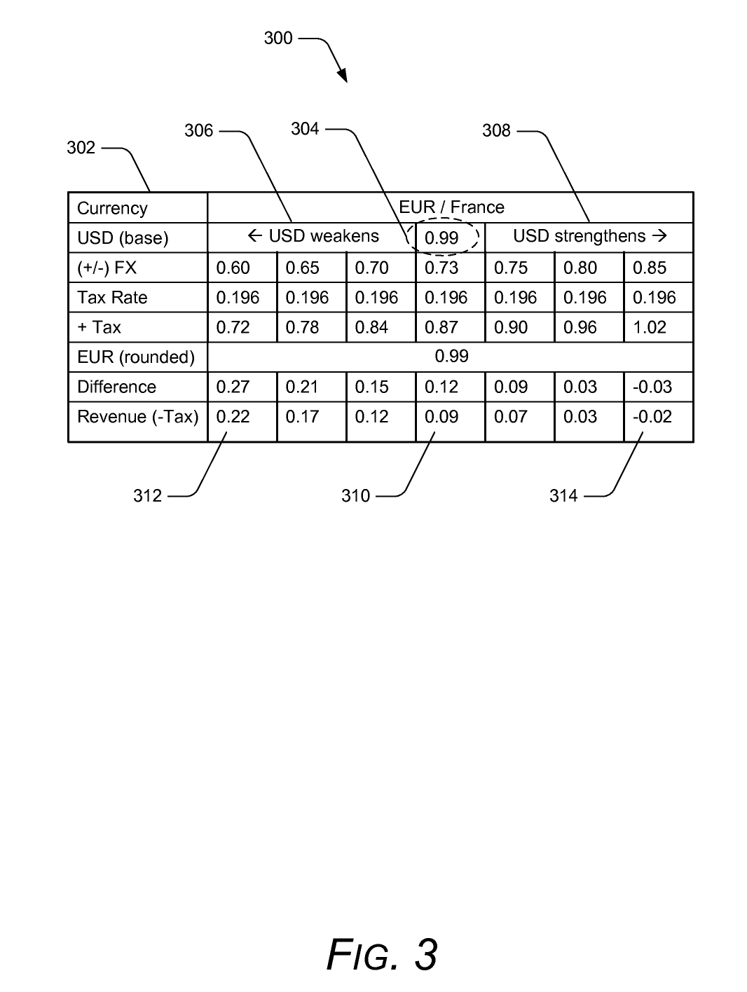

FIG. 3 illustrates an example 300 of projected exchange rate fluctuations as described with reference to FIG. 1. The example 300 considers the exchange rate fluctuations for a currency 302, which in this example is the EUR in France, when a base price point 304 of $0.99 in USD weakens at 306 and strengthens a 308. The example 300 illustrates that, at the base price point of $0.99 in USD, the currency value equivalent is [symbol] 0.73 EUR, and the resultant revenue is [symbol] 0.09 EUR at 310. As the USD weakens, a currency value equivalent of [symbol] 0.60 EUR results in a revenue increase to [symbol] 0.22 EUR at 312. As the USD strengthens, a currency value equivalent of [symbol] 0.85 EUR results in a revenue decrease to − [symbol] 0.02 EUR at 314. If the USD is projected or expected to strengthen, then the global price of [symbol] 0.73 EUR can be adjusted (i.e., as corresponding to the base price point of $0.99 in USD) to avoid a situation of negative revenue for a sale of content in France.

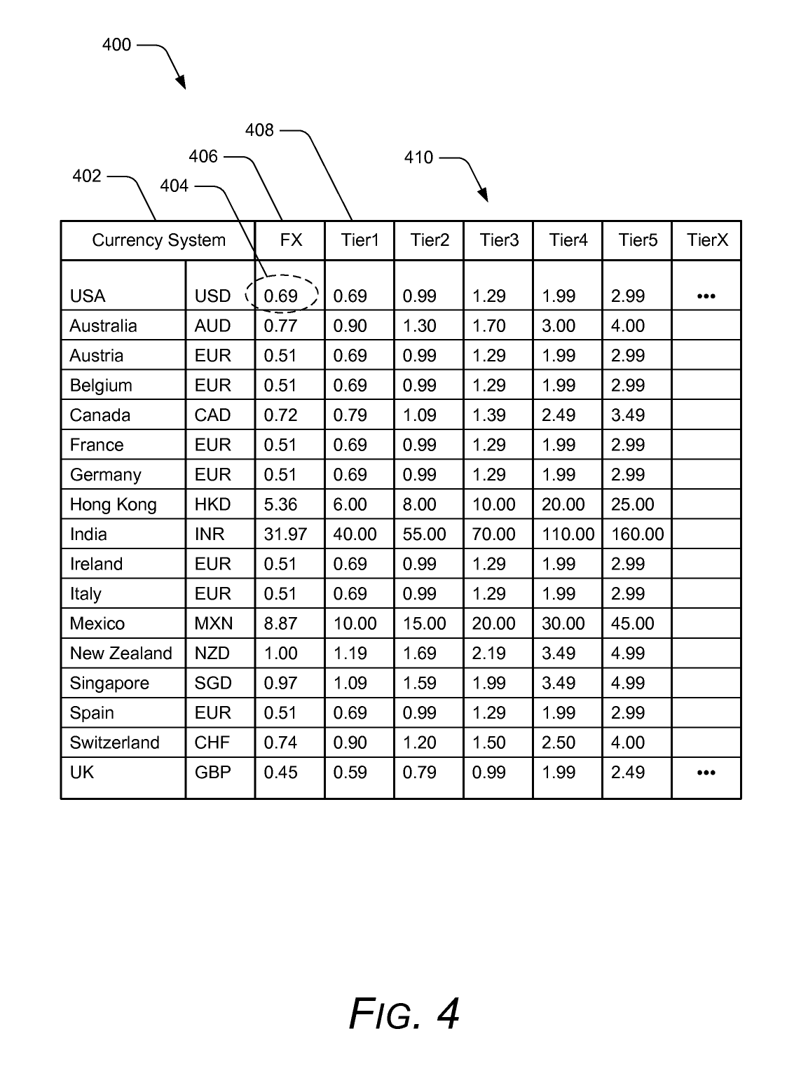

FIG. 4 illustrates an example of price tiers 400 as described with reference to FIG. 1. The price tiers 400 include various currencies 402, and a base price point 404 of $0.69 in USD. The price tiers also include the currency value equivalents 406 of the selected base price point for the multiple currencies. As described herein, the base prices in the price tier include the base price point 404 and the currency value equivalents 406. The price tiers 400 include tax-based prices for each of the respective currencies increased to a common price ending, which are reflected as the Tier1 global base prices 408. The price tiers 400 also include the additional price tiers 410, identified as Tier2 through TierX. The additional price tiers are generated to include global prices based on the increment values for each of the respective multiple currencies.

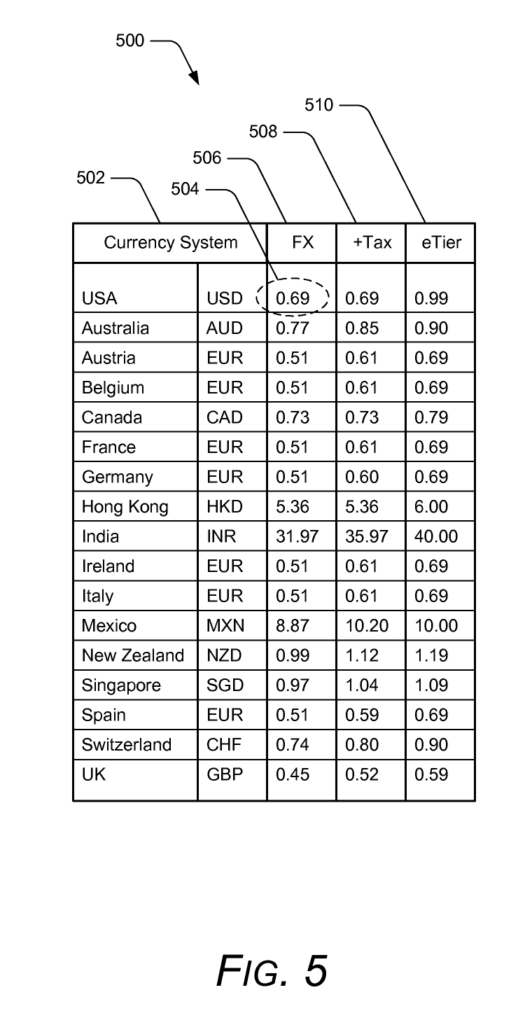

FIG. 5 illustrates an example exception price tier 500 as described with reference to FIG. 1. The exception price tier 500 includes various currencies 502, and an exception price point 504 of $0.69 in USD. The exception price tier also includes the currency value equivalents 506 of the exception price point for the multiple currencies. As described herein, the exception prices in the exception price tier include the exception price point 504 and the currency value equivalents 506.

The exception price tier 500 also includes the tax-based exception prices 508, which are the calculated tax amounts added to the exception prices for each the respective currencies 502 in which the calculated tax amount is collected along with a sale of the content. The exception price tier also includes the tax-based exception prices for each of the respective currencies increased to a common price ending, which are reflected as the eTier global exception prices 510.

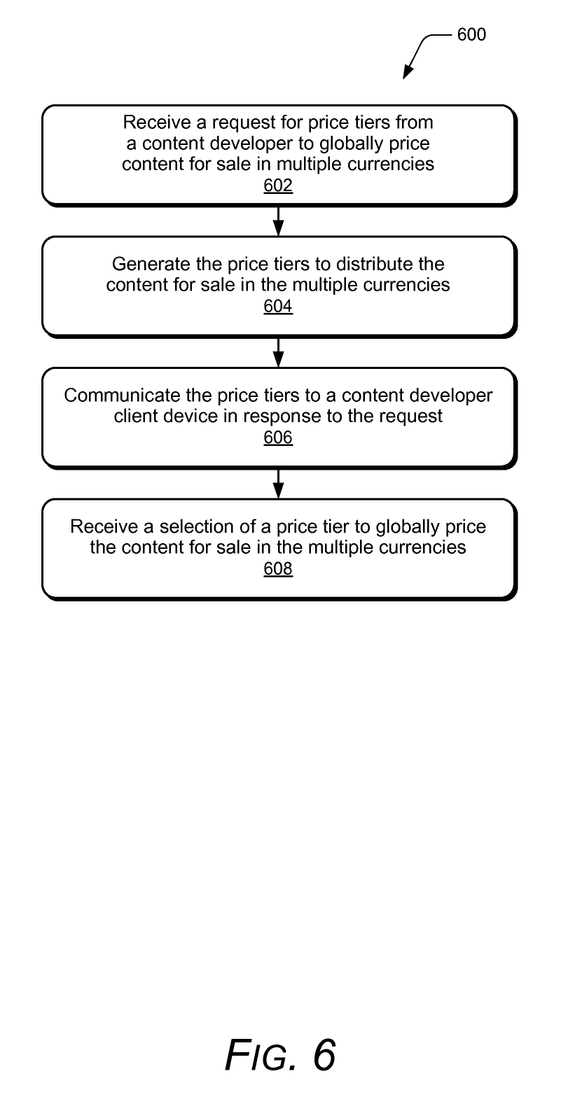

Example methods 600, 700, 800, and 900 are described with reference to respective FIGS. 6, 7, 8, and 9 in accordance with one or more embodiments of global pricing for content distribution. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

FIG. 6 illustrates example method(s) 600 of global pricing for content distribution, and is described with reference to a content developer interfacing with the pricing service. The order in which the method blocks are described are not intended to be construed as a limitation, and any number of the described method blocks can be combined in any order to implement a method, or an alternate method.

At block 602, a request is received from a content developer for price tiers to globally price content for sale in multiple currencies. For example, the content market service 102 (FIG. 1), and the pricing service 116 via the pricing service interface 118, receives a request from a content developer at client device 108 for the price tiers 122 in a base currency to price content for sale in multiple currencies 124, such as to set global prices for content that the content developer has created and uploaded to the content market service for sale and distribution.

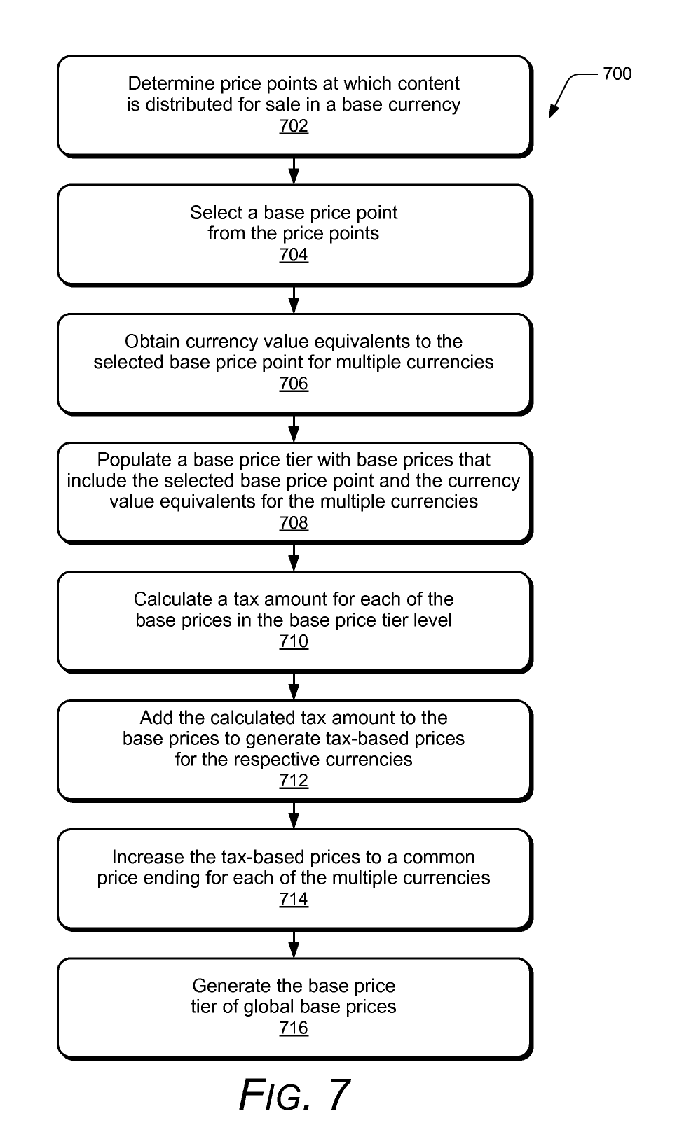

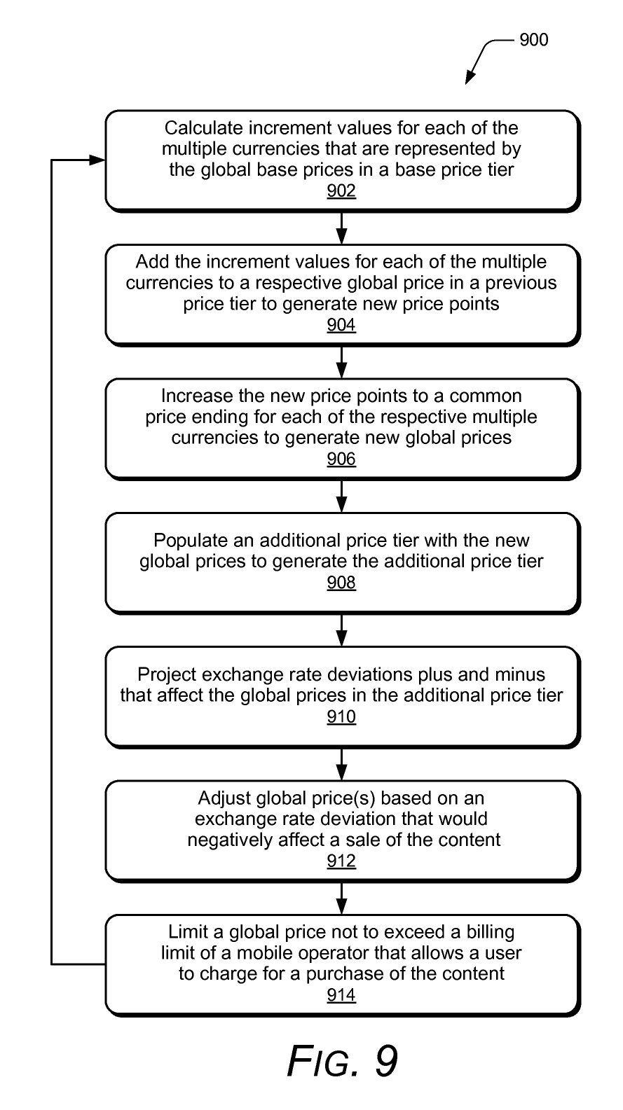

At block 604, the price tiers are generated to distribute the content for sale in the multiple currencies. For example, the pricing service 116 generates the price tiers 122 to distribute the content 104 for sale in multiple currencies 124. The pricing service 116 generates a base price tier as described with reference to FIG. 7, and generates subsequent, additional price tiers as described with reference to FIG. 9.

At block 606, the price tiers are communicated to a content developer client device in response to the request. For example, the content market service 102 communicates the price tiers 122 that are generated by the pricing service 116 back to the content developer at the client device 108 via the pricing service interface 118.

At block 608, a selection of a price tier is received to globally price the content for sale in the multiple currencies. For example, the content market service 102, and the pricing service 116 via the pricing service interface 118, receives a selection of a price tier from the content developer at client device 108 to globally price the content 104 for sale in the multiple currencies.

FIG. 7 illustrates example method(s) 700 of global pricing for content distribution, and is described with reference to generating a base price tier. The order in which the method blocks are described are not intended to be construed as a limitation, and any number of the described method blocks can be combined in any order to implement a method, or an alternate method.

At block 702, price points at which content is distributed for sale in a base currency are determined. For example, the pricing service 116 (FIG. 1) initially determines distribution price points 126 at which the content 104 is distributed for sale in a base currency. The content may include multiple types of content, and the pricing service determines the distribution price points at which the multiple types of the content are distributed for sale.

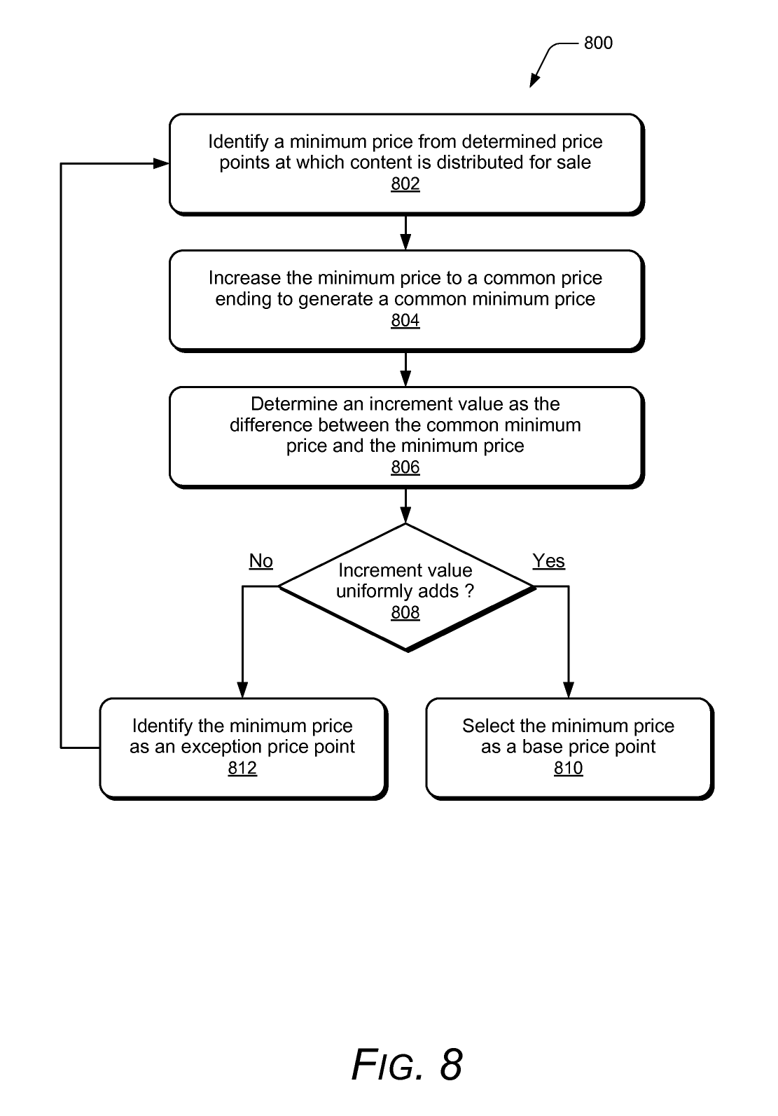

At block 704, a base price point is selected from the price points. For example, the pricing service 116 determines and selects a base price point 128, which is the price point in the base price tier from which the other global base prices are determined for the multiple currencies. The pricing service determines and selects a base price point as described with reference to FIG. 8.

At block 706, currency value equivalents to the selected base price point are obtained for multiple currencies. For example, the pricing service 116 obtains currency value equivalents 136 to the selected base price point for the multiple currencies 124. In embodiments, the pricing service auto-generates the global base prices for all of the currencies 124 from a base price point selected in one currency. The pricing service can request, and receive, the currency value equivalents from a currency exchange service.

At block 708, a base price tier is populated with base prices that include the selected base price point and the currency value equivalents for the multiple currencies. For example, the pricing service 116 populates the base price tier 200 (FIG. 2) with base prices that include the base price point 204 and the currency value equivalents 206.

At block 710, a tax amount for each of the base prices in the base price tier is calculated. For example, the pricing service 116 calculates a tax amount 140 for each of the base prices (i.e., the selected base price point 204 and the currency value equivalents 206 for the multiple currencies 202) in the base price tier 200. In embodiments, the pricing service calculates the tax amount for each of the base prices in the base price tier based on current tax rates that are associated with the respective multiple currencies.

At block 712, the calculated tax amount is added to the base prices to generate tax-based prices for the respective currencies. For example, the pricing service 116 adds the calculated tax amounts to the base prices to generate tax-based prices 208 for the respective currencies in which the calculated tax amount is collected along with a sale of the content. In countries (and for currencies) where the sale price of content includes a tax, the tax-based prices are calculated as the base price plus the base price multiplied by the tax rate. In countries (and for currencies) where the sale price of content excludes tax, the tax-based price is the same as the base price in the base price tier.

At block 714, the tax-based prices are increased to a common price ending for each of the multiple currencies and, at block 716, the base price tier of global base prices is generated. For example, pricing service 116 increases the tax-based prices 208 to a common price ending 134 for each of the multiple currencies 202 to generate the global base prices 210 in the base price tier.

FIG. 8 illustrates example method(s) 800 of global pricing for content distribution, and is described with reference to selecting a base price point. The order in which the method blocks are described are not intended to be construed as a limitation, and any number of the described method blocks can be combined in any order to implement a method, or an alternate method.

At block 802, a minimum price is identified from determined price points at which content is distributed for sale and, at block 804, the minimum price is increased to a common price ending to generate a common minimum price. For example, the pricing service 116 (FIG. 1) identifies a minimum price from the distribution price points 126 (e.g., as determined at block 702 in FIG. 7), and then the pricing service increases the minimum price to a common price ending to generate a common minimum price.

At block 806, an increment value is determined as the difference between the common minimum price and the minimum price. For example, the pricing service 116 determines an increment value 132 as the difference between the common minimum price and the minimum price. At block 808, a determination is made as to whether the increment value uniformly adds to global base prices in a base price tier to generate additional price tiers. For example, the pricing service 116 determines whether a calculated increment value 132 uniformly adds to the global base prices 210 in a base price tier 200 to generate additional price tiers 122.

If the increment value is determined to uniformly add to the global base prices to generate the additional price tiers (i.e., “yes” from block 808), then at block 810, the minimum price is selected as a base price point. For example, the pricing service 116 selects the minimum price as the base price point 204 if the calculated increment value 132 uniformly adds to the global base prices 210 to generate the additional price tiers 122.

If the increment value is determined not to uniformly add to the global base prices to generate the additional price tiers (i.e., “no” from block 808), then at block 812, the minimum price is identified as an exception price point. For example, the pricing service 116 identifies the minimum price as an exception price point 130 if the calculated increment value 132 does not uniformly add to the global base prices 210 to generate the additional price tiers 122. The method 800 then continues at block 802 to identify a next minimum price from the determined price points; at block 804 to increase the next minimum price to a common price ending to generate a common minimum price; at block 806 to determine the increment value as the difference between the common minimum price and the next minimum price; and at block 808 to determine whether the increment value uniformly adds to the global base prices to generate the additional price tiers.

FIG. 9 illustrates example method(s) 900 of global pricing for content distribution, and is described with reference to generating additional price tiers. The order in which the method blocks are described are not intended to be construed as a limitation, and any number of the described method blocks can be combined in any order to implement a method, or an alternate method.

At block 902, increment values are calculated for each of the multiple currencies that are represented by the global base prices in a base price tier. For example, the pricing service 116 (FIG. 1) calculates increment values 212 (FIG. 2) for each of the multiple currencies 202 that are represented by the global base prices 210 in a base price tier 200.

At block 904, the increment values for each of the multiple currencies are added to a respective global price in a previous price tier to generate new price points. For example, the pricing service 116 adds the increment values 212 for each of the multiple currencies 202 to a respective global price in a previous price tier (e.g., the Tier1 global base prices 210) to generate new price points (e.g., the base-plus-increment prices 214).

At block 906, the new price points are increased to a common price ending for each of the respective multiple currencies to generate new global prices and, at block 908, an additional price tier is populated with the new global prices to generate the additional price tier. For example, the pricing service 116 increases each of the new price points (e.g., the base-plus-increment prices 214) to a common price ending 134 for each of the respective multiple currencies 202 to generate the new Tier2 global base prices 216.

At block 910, exchange rate deviations plus and minus are projected that affect the global prices in the additional price tier and, at block 912, one or more of the global prices is adjusted based on an exchange rate deviation that would negatively affect a sale of the content. For example, the pricing service 116 projects exchange rate fluctuations or deviations plus and minus that may affect the global prices in a price tier (e.g., the Tier2 global base prices 216), and then adjusts the global prices based on an exchange rate deviation 142 that negatively affects a sale of the content.

At block 914, a global price is limited not to exceed a billing limit of a mobile operator that allows a user to charge for a purchase of the content. For example, the pricing service 116 limits a global price in a price tier so as not to exceed a billing limit 144 of a mobile operator 114 that allows a consumer to charge for a purchase of the content. Mobile operator billing systems can differ between the various mobile operators within a country or region, and some of the mobile operator billing systems can bill only specific, fixed price points. The pricing service 116 accounts for the specific, fixed price points for the various mobile operators and identifies the price tiers 122 which are supported and unsupported by the mobile operators. The method 900 may then continue to recursively repeat blocks 902-914 to generate additional price tiers.

FIG. 10 illustrates various components of an example device 1000 that can be implemented as any of the devices, or services implemented by devices, described with reference to any of the previous FIGS. 1-9 to implement embodiments of global pricing for content distribution. In embodiments, device 1000 may be implemented as any one or combination of a wired and/or wireless device, in any form of a device, such as a consumer, computer, server, portable, user, communication, phone, television, appliance, gaming, media playback, and/or electronic device. Device 1000 may also be associated with a user (i.e., a person) and/or an entity that operates the device such that a device describes logical devices that include users, software, firmware, hardware, and/or a combination of devices.

Device 1000 includes communication devices 1002 that enable wired and/or wireless communication of device data 1004 (e.g., received data, data that is being received, data scheduled for transmission, data packets of the data, etc.). The device data 1004 or other device content can include configuration settings of the device, media content stored on the device, and/or information associated with a user of the device. Media content stored on device 1000 can include any type of audio, video, and/or image data. Device 1000 includes one or more data inputs 1006 via which any type of data, media content, and/or inputs can be received, such as user-selectable inputs, messages, communications, music, television media content, recorded video content, and any other type of audio, video, and/or image data received from any content and/or data source.

Device 1000 also includes communication interfaces 1008 that can be implemented as any one or more of a serial and/or parallel interface, a wireless interface, any type of network interface, a modem, and as any other type of communication interface. The communication interfaces 1008 provide a connection and/or communication links between device 1000 and a communication network by which other electronic, computing, and communication devices can communicate data with device 1000.

Device 1000 includes one or more processors 1010 (e.g., any of microprocessors, controllers, and the like) which process various computer-executable instructions to control the operation of device 1000. Alternatively or in addition, device 1000 can be implemented with any one or combination of software, hardware, firmware, or fixed logic circuitry that is implemented in connection with processing and control circuits which are generally identified at 1012. Although not shown, device 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1000 also includes one or more memory devices (e.g., computer-readable storage media) 1014, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. Device 1000 may also include a mass storage media device.

A memory device 1014 provides data storage mechanisms to store the device data 1004, as well as various device applications 1016 and any other types of information and/or data related to operational aspects of device 1000. For example, an operating system 1018 and a pricing service 1020 can be maintained as software applications with a memory device 1014 and executed on processors 1010. The device applications 1016 may also include a device manager, such as any form of a control application, software application, signal processing and control module, code that is native to a particular device, a hardware abstraction layer for a particular device, and so on.

Device 1000 also includes an audio and/or video processing system 1022 that generates and provides audio data to an audio system 1024 and/or generates and provides display data to a display system 1026. The audio system 1024 and/or the display system 1026 can include any devices that process, display, and/or otherwise render audio, display, and image data. Display data and audio signals can be communicated from device 1000 to an audio device and/or to a display device via an RF (radio frequency) link, S-video link, composite video link, component video link, DVI (digital video interface), analog audio connection, or other similar communication link. In implementations, the audio system 1024 and/or the display system 1026 are external components to device 1000. Alternatively, the audio system 1024 and/or the display system 1026 are integrated components of example device 1000.

Although embodiments of global pricing for content distribution have been described in language specific to features and/or methods, the subject of the appended claims is not necessarily limited to the specific features or methods described. Rather, the specific features and methods are disclosed as example implementations of global pricing for content distribution.

1. A method, comprising:
determining price points at which content is distributed for sale, the price points being determined in a base currency;
identifying a minimum price from the determined price points;
increasing the minimum price to a common price ending to generate a common minimum price;
determining an increment value as the difference between the common minimum price and the minimum price;
selecting the minimum price as a base price point if the increment value uniformly adds to global base prices in a base price tier to generate additional price tiers; and
generating the base price tier of the global base prices from the selected base price point.

2. A method as recited in claim 1, further comprising:
determining that the increment value does not uniformly add to the global base prices to generate the additional price tiers;
identifying the minimum price as an exception price point;
identifying a next minimum price from the determined price points; and
repeating said:
identifying a next minimum price;
increasing the next minimum price to the common price ending to generate the common minimum price;
determining the increment value as the difference between the common minimum price and the next minimum price; and
selecting the next minimum price as the base price point if the increment value uniformly adds to the global base prices to generate the additional price tiers.

3. A method as recited in claim 2, further comprising generating an exception price tier of global exception prices based on the identified exception price point.

4. A method as recited in claim 1, wherein the content includes multiple types of the content, and the method further comprising determining the price points at which the multiple types of the content are distributed for sale.

5. A method as recited in claim 1, wherein said generating the base price tier of the global base prices from the selected base price point comprises:
obtaining currency value equivalents to the selected base price point for multiple currencies;
populating the base price tier with base prices that include the selected base price point and the currency value equivalents for the multiple currencies;
calculating a tax amount for each of the base prices in the base price tier;
adding the calculated tax amount to the base prices to generate tax-based prices for respective currencies in which the calculated tax amount is collected along with a sale of the content; and
increasing the tax-based prices to the common price ending for each of the multiple currencies to generate the global base prices in the base price tier.

6. A method as recited in claim 5, wherein the tax amount for each of the base prices in the base price tier is calculated based on current tax rates that are associated with the respective multiple currencies.

7. A method as recited in claim 5, wherein said obtaining the currency value equivalents comprises requesting the currency value equivalents from a currency exchange service, and receiving the currency value equivalents from the currency exchange service.

8. A method as recited in claim 5, further comprising:
calculating increment values for each of the multiple currencies that are represented by the global base prices in the base price tier; and
generating the additional price tiers based on the increment values for each of the respective multiple currencies.

9. A method as recited in claim 8, wherein said generating an additional price tier comprises:
adding the increment values for each of the multiple currencies to a respective global price a previous price tier to generate new price points in the additional price tier; and
increasing the new price points to the common price ending for each of the respective multiple currencies to generate global prices in the additional price tier.

10. A method as recited in claim 9, further comprising limiting a global price not to exceed a billing limit of a mobile operator that allows a user to charge for a purchase of the content.

11. A method as recited in claim 9, further comprising:
projecting exchange rate deviations plus and minus that affect the global prices in the additional price tier; and
adjusting one or more of the global prices based on an exchange rate deviation that would negatively affect a sale of the content.

12. A content market service, comprising:
a pricing service interface configured for content developer access to a pricing service that is implemented for global pricing of content, the pricing service interface configured to receive a request from a content developer for price tiers to price the content for sale in multiple currencies;
at least a processor and memory to implement the pricing service that is configured to:
determine price points at which the content is distributed for sale;
identify a minimum price from the determined price points;
increase the minimum price to a common price ending to generate a common minimum price;
determine an increment value as the difference between the common minimum price and the minimum price;
select the minimum price as a base price point if the increment value uniformly adds to global base prices in a base price tier to generate additional price tiers; and
generate the base price tier of global base prices from the selected base price point.

13. A content market service as recited in claim 12, wherein the pricing service is further configured to:
determine that the increment value does not uniformly add to the global base prices to generate the additional price tiers;
identify the minimum price as an exception price point;
identify a next minimum price from the determined price points; and
the pricing service is further configured to recursively:
identify a next minimum price;
increase the next minimum price to the common price ending to generate the common minimum price;
determine the increment value as the difference between the common minimum price and the next minimum price; and
select the next minimum price as the base price point if the increment value uniformly adds to the global base prices to generate the additional price tiers.

14. A content market service as recited in claim 12, wherein, to generate the base price tier of the global base prices from the selected base price point, the pricing service is further configured to:
obtain currency value equivalents to the selected base price point for multiple currencies;
populate the base price tier with base prices that include the selected base price point and the currency value equivalents for the multiple currencies;
calculate a tax amount for each of the base prices in the base price tier;
add the calculated tax amount to the base prices to generate tax-based prices for respective currencies in which the calculated tax amount is collected along with a sale of the content; and
increase the tax-based prices to the common price ending for each of the multiple currencies to generate the global base prices in the base price tier.

15. A content market service as recited in claim 14, wherein the pricing service is further configured to calculate the tax amount for each of the base prices in the base price tier based on current tax rates that are associated with the respective multiple currencies.

16. A content market service as recited in claim 14, wherein, to obtain the currency value equivalents, the pricing service is further configured to request the currency value equivalents from a currency exchange service, and receive the currency value equivalents from the currency exchange service.

17. A content market service as recited in claim 14, wherein the pricing service is further configured to:
calculate increment values for each of the multiple currencies that are represented by the global base prices in the base price tier;
generate the additional price tiers based on the increment values for each of the respective multiple currencies, the increment values for each of the multiple currencies added to a respective global base price in the base price tier to generate new price points in an additional price tier, and the new price points increased to the common price ending for each of the respective multiple currencies to generate global prices in the additional price tier.

18. A content market service as recited in claim 17, wherein the pricing service is further configured to:
project exchange rate deviations plus and minus that affect the global prices in the additional price tier;
adjust one or more of the global prices based on an exchange rate deviation that would negatively affect a sale of the content; and
limit a global price not to exceed a billing limit of a mobile operator that allows a user to charge for a purchase of the content.

19. A method, comprising:
receiving a request from a content developer for price tiers to globally price content for sale in multiple currencies, the request designating a base currency;
determining price points at which the content is distributed for sale in the base currency;
selecting a base price point from the price points;
obtaining currency value equivalents to the selected base price point for the multiple currencies;
populating a base price tier with base prices that include the selected base price point and the currency value equivalents for the multiple currencies;
calculating a tax amount for each of the base prices in the base price tier;
adding the calculated tax amount to the base prices to generate tax-based prices for respective currencies in which the calculated tax amount is collected along with a sale of the content;
increasing the tax-based prices to a common price ending for each of the multiple currencies to generate the base price tier of global base prices.

20. A method as recited in claim 19, further comprising:
calculating increment values for each of the multiple currencies that are represented by the global base prices in the base price tier; and
generating the price tiers based on the increment values for each of the respective multiple currencies.
